(19) United States
(12) Patent Application Publication
(10) Pub. No.: US 2016/0237330 A1
(43) Pub. Date: Aug. 18, 2016

(54) THERMAL INSULATOR WITH THERMALLY-CYCLABLE PHASE CHANGE MATERIAL

(71) Applicant: CoolComposites Inc., Waltham, MA (US)

(72) Inventors: Alan Ransil, Waltham, MA (US); Wenhao Sun, Berkeley, CA (US)

(73) Assignee: CoolComposites Inc., Waltham, MA (US)

(21) Appl. No.: 15/016,746

(22) Filed: Feb. 5, 2016

Related U.S. Application Data
(60) Provisional application No. 62/113,438, filed on Feb. 7, 2015.

(51) Int. Cl. C09K 5/06; E04B 1/78

(52) U.S. Cl. CPC C09K 5/063; E04B 1/78

(57) ABSTRACT

According to one or more embodiments, particles comprising a phase change material, and composite insulation materials incorporating the particles are disclosed. Related methods are also disclosed.

### RELATED APPLICATIONS

This application claims the benefit of U.S. provisional Patent Application Ser. No. 62/113,438, filed Feb. 7, 2015, entitled “A Rigid Thermal Insulator With Thermally Cyclable Inorganic Phase Change Material,” which is incorporated by reference herein in its entirety and for all reasons.

### FIELD

The present disclosure relates to the field of insulation, phase change materials, composite insulation materials incorporating phase change materials, and related methods.

### BACKGROUND

In order to minimize the energy costs or otherwise increase the efficiency of maintaining a room or other enclosure at a desired temperature, insulation materials are often placed in the envelope of the room or enclosed space, to reduce heat transfer through the boundaries. These insulation materials are often low-density, porous materials with enclosed pockets of gas.

Phase-change materials (PCMs) have sometimes been incorporated into insulation materials. Phase-change materials are materials that undergo a first-order phase transition, such as a solid-liquid melting transition, at a temperature between the desired temperature of an enclosure and the external temperature. Phase-change materials capture a portion of the incoming heat as latent heat, as opposed to conducting that heat further into the enclosure.

Technical barriers have limited the application of certain phase-change materials. For example, certain phase change materials are expensive, have a low volumetric latent heat, are flammable, can degrade in polymer insulations, are not thermally reversible, and/or are difficult to incorporate into conventional insulation material.

It would therefore be beneficial to provide materials and methods that address these and/or other drawbacks.

### SUMMARY

Insulation materials including phase change materials and related methods are described herein.

According to one or more embodiments, a series of materials and compositions are provided. In one or more embodiments, a composite foam insulation material is disclosed. The material comprises a foam insulation matrix and a plurality of particles distributed within the foam insulation matrix. The particles may have an average diameter of between 0.1 and 200 microns and comprise a thermally-cyclable inorganic phase change material capable of undergoing a reversible phase change.

According to some embodiments, the particles may further comprise a nucleating agent. The thermally-cyclable inorganic phase change material may comprise an inorganic salt solvate. The thermally-cyclable inorganic phase change material may comprise at least one of hydrated calcium chloride, hydrated manganese nitrate, and hydrated manganese chloride. The phase change material may have a first melting temperature, the nucleating agent may have a second melting temperature, and the second melting temperature may be greater than that of the first melting temperature.

According to some embodiments, the plurality of particles may comprise more than 0.5% nucleating agent by weight and less than or equal to 10% nucleating agent by weight. The thermally-cyclable inorganic phase change material may have a specific latent heat of fusion of greater than or equal to 80 J/g and less than or equal to 400 J/g. The thermally-cyclable inorganic phase change material may be capable of undergoing a reversible phase change within a temperature range of 5° C. The thermally-cyclable inorganic phase change material may be capable of undergoing a reversible phase change within a temperature range of 2° C. The thermally-cyclable inorganic phase change material may have an average melting point of greater than or equal to 15° C. and less than or equal to 35° C.

According to some embodiments, the foam insulation matrix may comprise a closed-cell foam insulation matrix. The foam insulation matrix may comprise a rigid foam insulation matrix. The foam insulation matrix may have an average cell volume of greater than or equal to 5×10⁻⁷ ml and less than or equal to 0.5 ml. The foam insulation matrix may comprise a material selected from the group consisting of polystyrene, polyurethane, polyisocyanurate, and polyethylene. The composite insulation material may comprise greater than 0.5% and less than or equal to 50% particles by volume.

In one or more embodiments, a composite foam insulation material is disclosed. The composition may comprise a plurality of particles, the particles having an average diameter of between 0.1 and 200 microns and comprising a nucleating agent and a thermally-cyclable inorganic phase change material capable of undergoing a reversible phase change.

According to some embodiments, the thermally-cyclable inorganic phase change material may comprise an inorganic salt solvate. The thermally-cyclable inorganic phase change material may comprise at least one of hydrated calcium chloride, hydrated manganese nitrate, and hydrated manganese chloride. The nucleating agent may comprise hydrated strontium chloride. At least 95% of the total number of particles in the composition may include nucleating agent. The material composition may be a powder. The plurality of particles may comprise more than 0.5% nucleating agent by weight and less than or equal to 10% nucleating agent by weight.

According to some embodiments, each of the plurality of particles may further comprise an encapsulant. The encapsulant may comprise a material selected from a group consisting of polyethylene, polystyrene, nylon, polyvinyldene fluoride, polycarbonate, polypropylene, polyvinylchloride, polyimide, polyamide, polyester, and copolymers thereof. The thermally-cyclable inorganic phase change material may be capable of undergoing a reversible phase change within a temperature range of 5° C. The thermally-cyclable inorganic phase change material may be capable of undergoing a reversible phase change within a temperature range of 2° C.

According to one or more embodiments, a series of methods are provided. In one or more embodiments, a method of forming a composite insulation material is provided. The method may comprise mixing together a plurality of particles and a precursor of a foam insulation matrix, wherein the particles have an average diameter of between 0.1 and 200 microns and comprise a thermally-cyclable phase change material capable of undergoing a reversible phase change; and allowing the precursor to foam and cure to form a composite insulation material comprising the plurality of particles distributed in a foam insulation matrix.

According to some embodiments, the particles may further comprise a nucleating agent. The method may further comprise spraying or extruding the mixture of precursor and phase change particles. The foam precursor may comprise a polyurethane multipart formulation. The foam precursor may comprise polystyrene. The foam precursor may comprise expandable polystyrene beads.

In one or more embodiments, a method is provided for producing particles comprising nucleating agent and thermally-reversible inorganic phase change material particles, the particles having an average diameter of between 0.1 and 200 microns and capable of undergoing a reversible phase change. The method may comprise heating a mixture of an inorganic phase change material and a nucleating agent to a temperature above the melting point of the inorganic phase change material to produce a heated mixture; adding the heated mixture to a solution having a temperature below the melting point of the inorganic phase change material and sufficient to induce crystallization in the inorganic phase change material to produce a cooled mixture; stirring the cooled mixture to produce an emulsion comprising particles, the particles having an average diameter of between 0.1 and 200 microns and comprising nucleating agent and thermally-reversible inorganic phase change material particles; and collecting the particles from the emulsion.

In some embodiments, the heated mixture may comprise a homogeneous solution. The heated mixture may comprise an inhomogeneous dispersion. The cooled mixture may comprise an aprotic solvent and a surfactant. The cooled mixture may further comprise a stabilizer. The method may further comprise encapsulating the particles.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic view of a composite insulation material, according to one or more embodiments of the present disclosure;

FIG. 2 is a set of graphs representing a temperature profile over distance in a standard insulation material and in a disclosed composite insulation material according to one or more embodiments of the present disclosure;

FIG. 3 is a set of graphs representing heat flow through a standard insulation material and a disclosed composite insulation material according to one or more embodiments of the present disclosure;

FIG. 4 is a schematic view of a particle according to at least one embodiment of the present disclosure; and

FIG. 5 is a schematic view of a particle according to at least one embodiment of the present disclosure.

### DETAILED DESCRIPTION

Insulation materials including phase change materials and related methods are described herein. According to one or more embodiments, composite foam insulating materials are disclosed having particulate inorganic phase change materials distributed within a foam matrix. As discussed further below, the inorganic phase change material may capture a portion of the heat being transferred through the composite material and store it as latent heat, resulting in improved performance of the insulation material. The composite materials may reduce operational costs of cooling enclosed spaces, by minimizing thermal transport through the insulation material. According to certain embodiments minimizing thermal transport is achieved by increasing the effective heat capacity of the composite insulation material, and/or by achieving a low thermal gradient at a boundary of the envelope formed by the composite insulation material. Insulating material may be generally understood to be a material with a thermal conductivity value lower than 0.5 W/(K*m). The disclosed composite foam insulation materials may be used in a variety of applications, such as building envelope insulation, refrigeration, coolant transport, pipe insulation, medical transport, refrigerated freight of food or other temperature-sensitive objects.

According to one or more embodiments particles comprising thermally-reversible phase change materials are disclosed. The particles may be microparticles (e.g., particles having a diameter of 0.1 to 200 microns, where diameter is the distance in three-dimensional space between the farthest two points within a particle). The particles may further comprise nucleating agents which aid in making the phase change material thermally reversible.

Phase change materials are materials that undergo a phase transition, such as a liquid-to-solid or solid-to-liquid transition, within the range of expected temperatures during normal operation. According to certain embodiments, PCMs may undergo thermally reversible phase changes. Thermal reversibility may be understood as the capability of having a phase change that occurs in both the forward (e.g., melting) and reverse (e.g., freezing) directions, with the phase changes in either direction occurring within a certain temperature range of each other, for example, according to certain embodiments, the phase changes may occur within a range of 10° C., of 8° C., of 6° C., of 5° C., of 4° C., of 3° C., of 2° C., of ° C., or at substantially the same temperature. In a thermally reversible phase change the potential for or extent of supercooling is reduced. Thermally cyclable may be understood as repeatedly thermally reversible.

According to certain embodiments phase change material is incorporated into a composite insulation material, otherwise referred to as a thermal insulator, to increase the thermal mass of insulation as well as to lower the thermal gradient within the insulation by resisting changes in temperature. For example, when placed in building insulation the phase change material is able to lower the amount of heat that travels through the insulation into a building on a warm day by storing heat. At night, when the outdoor temperature decreases below the PCM transition temperature, the material releases that stored heat. PCMs able to take advantage of thermal cycling in this way must have a transition temperature in-between the extremes of that temperature cycle. For a home or office building, a transition temperature for the phase change material may be between 15° C. and 50° C. In some cases such as refrigerated enclosures or pipes, a wider range such as 0° C. to 100° C. may be advantageous. In some embodiments a wider range of −20° C. to 200° C. may be advantageous. In some embodiments the phase change material may have a transition temperature between 20° C. and 40° C., or between 25° C. and 35° C.

The application of phase change material in a microparticle form provides several advantages over macroencapsulation techniques. While macroencapsulation has been employed to incorporate PCMs into some buildings and devices, these strategies generally involve modifications to the construction and design process of the building or device. Changes involve, for example, addition of an extra PCM layer to a building envelope or the filling of void space in a wall by PCM-containing objects. By contrast, microparticles can be incorporated into insulating materials that are already used in a construction process. For example, microparticles may be incorporated into wallboards, open-cell and flexible foams, and fibers for textiles. Microparticle PCMs thus can provide improved thermal properties through a drop-in solution that does not add significant complexity or extra steps to a construction process. However, the microparticle form poses a challenge for producing inorganic PCMs contain nucleators for thermal reversibility. As these particles are non-communicating in the final composite, a nucleator in one particle will not induce a reversible transformation in a neighboring particle. Therefore, to ameliorate supercooling, nucleators are included in individual particles to facilitate a reversible transformation.

In some embodiments, an advantage to utilizing PCMs in a microscopic form is that such microparticles possess high surface area to volume ratios, which allows for more efficient (e.g., faster, more complete) phase transformation. This phase transition is accompanied by a reversible change in enthalpy, providing a means of storing heat over a narrow temperature range. An advantage of using an inorganic phase change material is that such materials, such as hydrated salts, are often flame retardant, have high thermal gravimetric density, can be produced from relatively inexpensive raw materials and are immiscible with many polymer solutions.

According to one or more embodiments, the microparticles may be embedded into an insulation matrix to provide an improved foam insulation material.

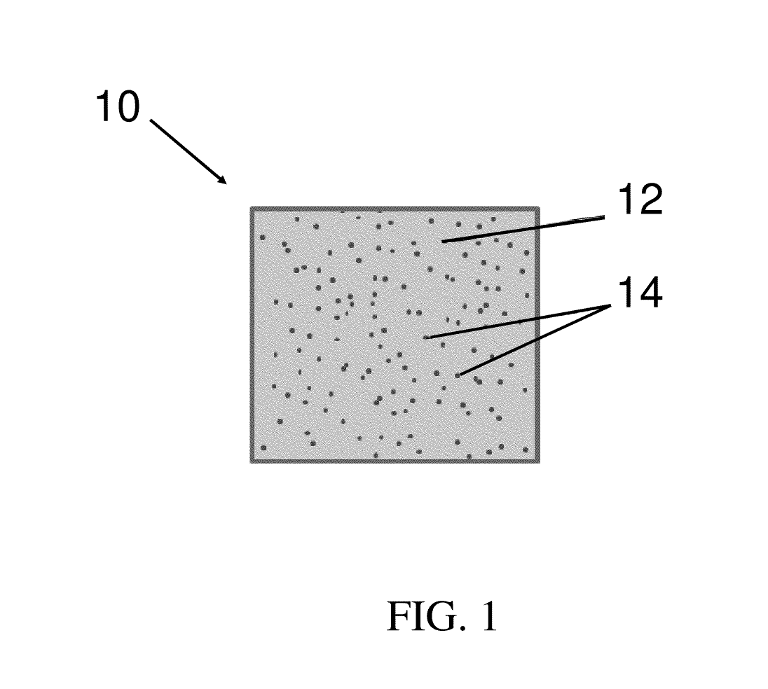

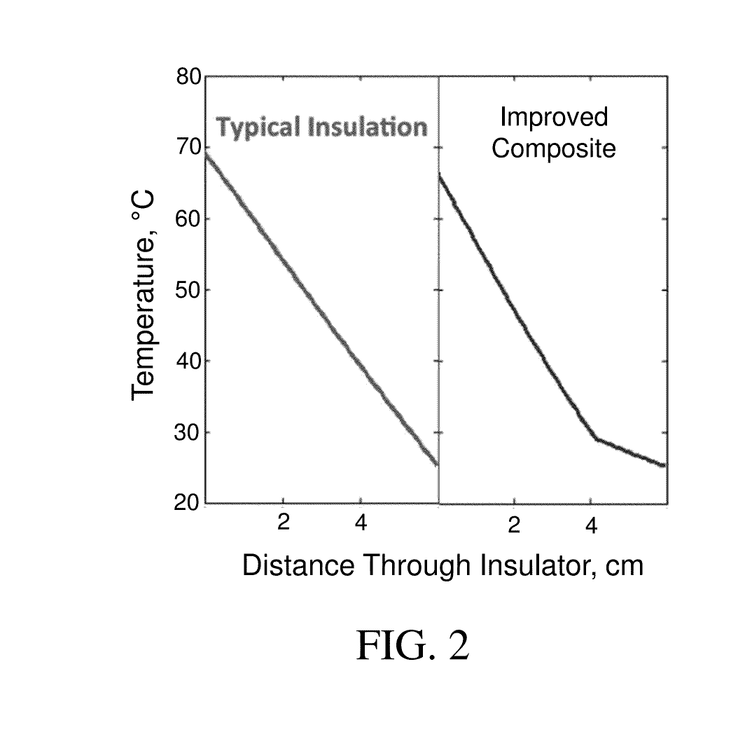

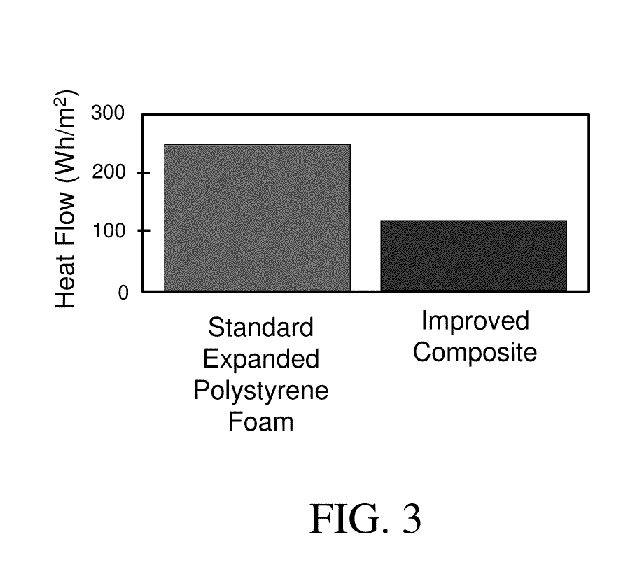

FIG. 1 shows a composite material 10, according to one or more embodiments. The composite material 10 comprises a rigid, hydrophobic thermal insulation matrix 12 embedded with PCM particles 14. In the embodiment shown in FIG. 1, the PCM particles 14 constitute between 1% and 50% of the composite 10 by volume. The presence of PCM particles 14 at this ratio improves the properties of the insulator as demonstrated in finite element simulations as shown in FIGS. 2 and 3. The composite material 10 is able to be integrated into buildings with minimal redesign. The insulation matrix may comprise a rigid foam in which the majority of the cells are isolated from adjacent cells (i.e., a closed-cell foam). A closed-cell foam is a foam in which the majority of cells are divided from each other by the walls of the foam material. This is contrasted to open-cell foams, in which the cells are divided by struts that do not on average isolate one cell from adjacent cells. According to certain embodiments, the foam insulation matrix may have an average cell volume of greater than or equal to 5×10⁻⁷ ml and less than or equal to 0.5 ml.

According to certain embodiments, the foam may be produced on-site, for example by a spray process, or pre-fabricated. Particular examples of foam species include, without limitation, polystyrene, polyurethane, polyisocyanurate, and polyethylene.

In some embodiments this matrix may be a rigid hydrophobic insulating foam. In embodiments in which the matrix is rigid, composite panels may be easily integrated into existing building designs. A rigid foam may be understood to be a foam, such as polyurethane or polystrene, that undergoes brittle fracture when tested to failure. This is in contrast to, for example, flexible polyurethane foams that may be deformed. While rigid foams generally have a higher Young's modulus (above approximately 100 kPa), there is overlap in the Young's modulus of the two foam types. While rigid foams tend to be closed-cell and high density and flexible foams tend to be open-cell and low density, counterexamples exist.

A rigid composite structure aids, for example, in the fabrication of structural insulated panels (SIPs) comprising an insulator sandwiched between rigid sheets. In this case, the rigidity of the insulator provides a component of the overall panel's structural integrity. In another example, a rigid structure facilitates the incorporation of various embodiments of the disclosed structure in the building of roofs. Using an EPDM roofing system typical in large commercial buildings, it is necessary that the insulating layer used be structurally rigid and resistant to crushing in order to maintain acceptable thermal properties.

When integrating non-structural additives into materials, high volumes of additive tend to structurally degrade the material. Thus it is the volume of PCM particles, rather than the mass of the particles, that dictates the amount of PCM that can be included in a practical composite insulation material. While many inorganic PCMs tend to have comparable gravimetric latent heat values to organic PCMs, their greater density tends to result in a higher volumetric latent heat. The use of an inorganic PCM thus allows insulation composites with a high latent heat while minimally interfering with the structural integrity of the matrix.

According to one or more embodiments, the composite insulation material may comprise a certain percentage of particles by volume. In certain embodiments, the composite insulation material comprises particles by volume at greater than 0.1%, greater than 0.5%, greater than 1%, greater than 2%, greater than 5%, greater than 10%, greater than 20%, greater than 30%, or greater than 40%. In certain embodiments, the composite insulation material comprises particles by volume at less than or equal to 50%, less than or equal to 40%, less than or equal to 30%, less than or equal to 20%, less than or equal to 10%, less than or equal to 5%, less than or equal to 2%, or less than or equal to 1%. Combinations of the above ranges are also possible (e.g., greater than 1% and less than or equal to 50%). Other ranges are also possible

According to one or more embodiments, methods are disclosed for fabricating a composite insulating material comprising a foam insulation matrix and microparticles comprising thermally reversible inorganic phase change materials.

The thermally-reversible microparticles, which may be in a powder form, may be mixed together with a precursor of a foam insulation matrix. The precursor may be any known precursor of a foam insulation matrix, as will be understood by a person of ordinary skill in the art, for example, polyurethane, polystyrene, etc. The precursor may be present in a variety of forms (e.g., liquid, bead, etc.). The precursor may comprise a single or multipart formulation having more than one component, for example, a polyurethane multipart formulation, sometimes referred to as a “mix and pour” foam. Where the precursor comprises a multipart formulation, the microparticles may be mixed into one or more components of the precursor, prior to, during, or after mixing the precursor components.

Once the microparticles and precursor are mixed, the precursor may be allowed to foam and cure to form a composite insulating material, comprising the plurality of microparticles distributed into the foam insulation matrix.

Prior to or concurrent to allowing the precursor to foam and cure, the mixture may be sprayed or extruded. The particles may be added to spray polyurethane foams, in which case the particles are extruded from a nozzle along with the foam precursors. Alternatively, the particles may be added to polystyrene in order to form rigid, closed cell polystyrene composites. They may be added to polystyrene prior to extrusion, or to polystyrene beads prior to expansion into a foam.

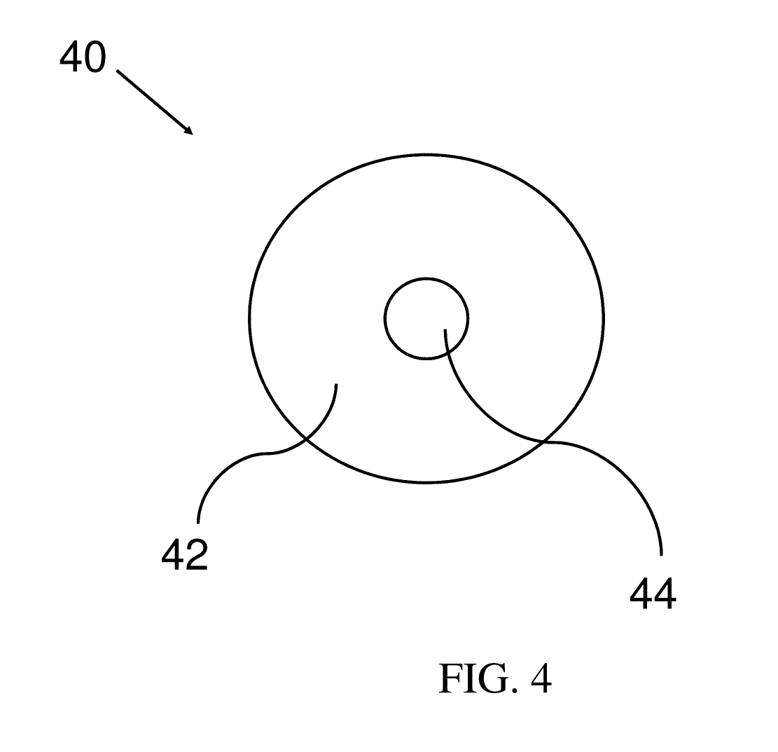

FIG. 4 shows a thermally-reversible inorganic phase change material microparticle 40. The microparticle 40 comprises an inorganic phase change material 42 that surrounds one or more nucleating agents 44.

The inorganic phase change material may comprise one or more inorganic salt solvates. Inorganic salt solvates are materials comprising an inorganic salt and a solvent. One example of a solvate is a hydrate. In some embodiments, the ratio of solvent to salt may be above 5% by weight, above 10% by weight, above 15% by weight, or above 20% by weight. When in a closed chemical system, the freezing of these highly ionic systems results in crystals with a large ratio of included solvent. While ionic salts generally have melting temperatures of several hundred degrees Celsius, the inclusion of solvent into the crystal reduces the lattice cohesive energy of the inorganic salt, and thereby, brings melting temperatures of the ionic salts to near ambient conditions. As phase change materials that exploit a solid-liquid phase transition, inorganic salt solvates (e.g., inorganic salt hydrates) tend to have high volumetric latent heats and exhibit lower costs than traditional organic phase change materials. Many also possess flame-retardant properties, which make them additionally attractive for insulation purposes in building or transportation systems.

The inorganic phase change material may comprise one or more inorganic salt solvates. Inorganic salt solvate compositions are composed of one or more cations, one or more anions, and small solvent molecules (i.e., molecules having a molecular weight of 900 g/mol or less) in the crystalline lattice. The cations can be alkali metals (Li⁺, Na⁺, K⁺, Cs⁺), alkali earth metals (Mg²⁺, Ca²⁺, Sr²⁺, Ba²⁺), transition metals (such as, but not limited to Fe²⁺, Mn²⁺, Mn⁴⁺, Cu²⁺, Zn²⁺ or other metal ions and oxidation states), or complex cations such as NH₄⁺. Anions tend to be halides (F⁻, Cl⁻, Br⁻, I⁻), or complex anions (such as, but not limited to CO₃²⁻, IO₃⁻, OH⁻, ClO₄⁻, NO₃⁻, PO₄³⁻). Small solvate molecules include, but are not limited to, H₂O, NH₃, urea CO(NH₂)₂, ethanol CH₃—CH₂—OH, and methanol CH₃—OH. The inorganic salt solvate may be a hydrated inorganic salt. Examples of the inorganic salt solvate may include, without limitation, hydrated calcium chloride (CaCl₂.6H₂O), hydrated manganese nitrate Mn(NO₃)₂.6H₂O, and hydrated manganese chloride MnCl₂.4H₂O. The phase change material may comprise one or more inorganic salt solvates, for example, it may comprise a manganese-based system consisting of a mixture of hydrated manganese nitrate Mn(NO₃)₂.6H₂O, and hydrated manganese chloride MnCl₂.4H₂O.

Many inorganic salt hydrates exhibit significant undercooling, or supercooling, in order to recrystallize. A nucleating agent is used to reduce this undercooling required to recrystallize by catalyzing the crystallization process, either by reducing the homogeneous nucleation barrier by a surfactant, or by providing a substrate or foreign particle on which to heterogeneously nucleate. In general, nucleating agents are foreign particles, substrates, or surfactants chemically distinct from the phase change material they are surrounded by. Nucleators generally do not contribute to the overall latent heat stored by the microparticle. However, when the particle is brought below the transformation temperature of the PCM, the nucleator seeds the reverse transformation. In the case of a melting system, the nucleator seeds the solid phase and induces freezing. In many inorganic PCM systems, this significantly reduces supercooling.

According to certain embodiments the disclosed microparticles reduce supercooling of the phase change material. Inorganic phase change materials often exhibit supercooling, an effect by which the measured freezing temperature is below the melting temperature because of the thermodynamic driving force necessary to nucleate the solid phase. This effect can be substantial, with the freezing point measured to be more than 10° C. below the melting point, which lessens the utility of these materials in practical applications. As nucleation is a stochastic process, supercooling tends to worsen in small sample volumes such as powder additives. A nucleating agent is an impurity that can be added to a phase change material and which does not undergo a phase change over the temperature range of interest. The nucleating agent improves the thermal reversibility of the phase change material. Nucleators, or nucleating agents, are able to lessen supercooling by remaining solid when the remaining material melts, and nucleating the solid phase upon cooling. These agents can result in reduced supercooling, such that the phase change material solidifies and melts at temperatures within a certain range of each other. For example, the phase change material may solidify and melt at temperatures within 10° C. of each other, within 8° C., within 6° C., within 5° C., within 4° C., within than 3° C., within 2° C., or within 1° C. of each other, according to certain embodiments. The phase change material may solidify and melt at substantially the same temperature according to certain embodiments.

In some embodiments, the nucleating agent may be an inorganic salt solvate isostructural with the phase change material. An example of a nucleator shown to function well in the CaCl₂.6H₂O system is hydrated strontium chloride (SrCl₂.6H₂O). Some alternative nucleators include CaBr₂.6H₂O, BaI₂.6H₂O, and SrBr₂.6H₂O. Non-isostructural nucleators may include other inorganic materials such as silica or calcium carbonate.

So long as the operation temperature of the insulation does not exceed the melting temperature of the nucleator, this solid nucleating agent can be used to catalyze the refreezing of the phase change material.

The particles may comprise a certain percentage of nucleating agent by weight. In some embodiments, the particles may comprise more than 0.1% nucleating agent by weight, more than 0.5%, more than 1%, more than 2%, more than 4%, more than 6%, more than 8%, more than 10%, or more than 15%. In some embodiments, the particles may comprise less than or equal to 25% nucleating agent by weight, less than or equal to 15%, less than or equal to 10%, less than or equal to 8%, less than or equal to 6%, less than or equal to 4%, less than or equal to 2%, or less than or equal to 1%. Combinations of the above ranges are also possible (e.g., more than 1% and less than or equal to 10%). Other ranges are also possible.

The particles may have a certain average diameter according to some embodiments, where diameter is the distance in three-dimensional space between the farthest two points within a particle. According to some embodiments, the particles have an average diameter of about 0.1 to 200 microns. In some embodiments, the particles have an average diameter of between 10 and 100 microns. According to certain embodiments, the particles have an average diameter of greater than 0.1 microns, greater than 1 micron, greater than 10 microns, greater than 20 microns, greater than 50 microns, or greater than 100 microns. According to certain embodiments, the particles have an average diameter of less than or equal to 300 microns, less than or equal to 200 microns, less than or equal to 150 microns, less than or equal to 100 microns, less than or equal to 50 microns, less than or equal to 20 microns, or less than or equal to 10 microns. Combinations of the above ranges are also possible. Other ranges are possible.

According to certain embodiments, the phase change material has an average melting point (or transition temperature) of at least −20° C., at least 0° C., at least 10° C., at least 15° C., at least 20° C., at least 25° C., at least 30° C., at least 35° C., at least 40° C., at least 60° C., at least 80° C., at least 100° C., or at least 150° C. In certain embodiments, the phase change material has an average melting point (or transition temperature) of less than or equal to 200° C., of less than or equal to 150° C., of less than or equal to 100° C., of less than or equal to 80° C., of less than or equal to 60° C., of less than or equal to 40° C., of less than or equal to 35° C., of less than or equal to 30° C., of less than or equal to 25° C., of less than or equal to 20° C., of less than or equal to 15° C., of less than or equal to 10° C., or of less than or equal to 0° C. Combinations of the above-referenced ranges are also possible (e.g., at least 15° C. and less than or equal to 35° C.). Other ranges are also possible.

As the mode of operation of PCMs depends on latent heat storage, higher latent heats may enable improved operation. The embedded inorganic PCM generally have about twice the volumetric latent heat capacity of alternative organic PCMs.

According to some embodiments, the specific latent heat of fusion of the inorganic phase change material may be greater than or equal to 80 J/g and less than or equal to 400 J/g. According to some embodiments, the density of the solid inorganic particles may be between 1.4 g/ml and 3 g/ml.

According to one or more embodiments, individual microparticles further comprise an encapsulant, or coating that surrounds the PCM particle. The coating may provide a vapor barrier and/or liquid barrier. In some embodiments the coating may be hydrophobic. Hydrophobic may be understood to mean having energetically unfavorable interactions with water. In the case of a solid, this is indicated by an obtuse)(>90° contact angle of a water droplet on a planar surface of the solid.

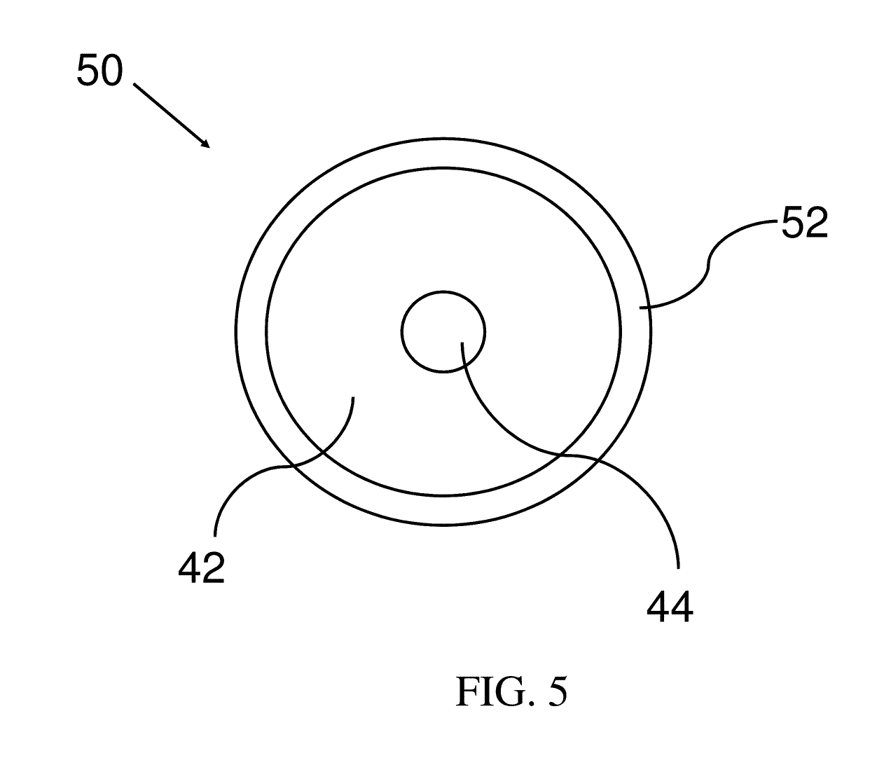

FIG. 5 shows an encapsulated thermally reversible inorganic phase change material microparticle 50. The microparticle 50 comprises an inorganic phase change material 42 that surrounds a nucleator 44 and that is surrounded by a solvent-barrier coating 52. The coating provides a barrier to both liquid solvent and solvent vapor. For example, where a hydrated salt is used as a phase change material, the coating is a water-barrier. It may provide a barrier to liquid. It may provide a barrier to both liquid and vapor.

Maintaining a constant water stoichiometry of an inorganic salt hydrate aids in allowing the transformation to continue to occur at the desired temperature. Because water can exchange with an open environment, for proper thermal-cyclability salt hydrates are preferably enclosed by a non-permeable water barrier.

This coating or encapsulant may comprise a polymer that is added during the process of producing the particles, before the particles are added to the foam into which they may ultimately be incorporated. This coating may stabilize the particles (so that they do not need to be kept in a climate-controlled environment during shipping and storage), form a vapor and chemical barrier allowing simple integration into the foam itself, alter the surface properties of the particles in order to better disperse them throughout the foam precursors, and improve the lifetime of the PCM particle once it is integrated into the foam.

An encapsulating coating contains the particle when it is in the melted solution state, and can also prevent the phase change material from chemical exchange with an external environment, which may compromise the thermal properties of the phase change material. Such an encapsulant may be a complete seal, surrounding the phase change material and preventing any material from escaping the coating, or allowing any foreign chemical species to interact with the coating. According to certain embodiments, the encapsulant may be hydrophobic.

According to some embodiments, the insulation matrix into which the microparticles are distributed, may accomplish the functions of the encapsulation coatings. In such embodiments, a separate encapsulant may or may not surround the microparticles. For example, where the insulation material is hydrophobic, space-filling, and can form closed cells, it is possible that the insulation material can serve some of the functions of the encapsulating coating. For example, polyurethane may be foamed from precursors with an inorganic phase change material present, thus encapsulating the inorganic PCM directly into the cells of the foam.

Encapsulants are generally polymers that can form complete shells around inorganic PCM particles, including but not limited to polyethylene, polystyrene, nylon, polyvinyldene fluoride, polycarbonate, polypropylene, polyvinylchloride, polyimide, polyamide, polyester, copolymers including any of these polymers, or multilayers including any of these materials. The thickness of these encapsulating walls is determined by a trade-off between the permeability of the encapsulant to small molecules, and the effect of the encapsulate on the average latent heat of the particles. In the case of particles intended to be added to vapor-impermeable insulation, an encapsulating layer in the nanometer thickness range may be used. Thicker coatings, up to several microns thick, may be necessary in some applications in order to improve the aging properties of the composites.

In a bulk state prior to introduction to an insulating matrix, the particles may take a powder form.

According to certain embodiments, methods are disclosed for producing microparticles comprising nucleating agent and thermally-reversible inorganic phase change material particles capable of undergoing a reversible phase change. According to certain embodiments, the phase change microparticles may be fabricated using a microemulsion process.

Initially, a mixture of an inorganic phase change material and a nucleating agent may be heated to a temperature above the melting point of the inorganic phase change material to produce a heated mixture. A solution or suspension is formed by melting the phase change material and by adding the nucleator material. According to some variants, the mixture is heated sufficiently to dissolve the nucleator in the phase change material. According to other variants, the nucleator is dispersed in the phase change material solution. The heated mixture may comprise a homogeneous or inhomogeneous solution.

The heated mixture may be added to a solution having a temperature below the melting point of the inorganic phase change material and sufficient to induce crystallization in the inorganic phase change material to produce a cooled mixture. An emulsifying solution is prepared which contains a solvent in which the phase change material is insoluble or substantially insoluble. For example, if the phase change material is a hydrated salt the solution employs an aprotic solvent such as toluene or octadecene. A surfactant is dissolved in this second solution, and a stabilizer may be dissolved in addition. Surfactants in the systems discussed include, for example, Span-60 and oleic acid. The solution may be cooled below the melting point of the phase change material. In some variants, the solution is cooled substantially below the melting point of the phase change material in order to rapidly induce freezing.

This emulsifying solution may be stirred (e.g., stirred rapidly) and the phase change material mixture is added, forming an emulsion. Because the emulsifying solution has been cooled, the phase change material freezes to form solid microparticles. This process may be carried out using a wide range of solution volume ratios. In some variants, the volume of the emulsifying solution is approximately twice the volume of the phase change material solution.

According to certain embodiments the above method allows the production of a composition comprising microscale particles in which the majority of particles contain nucleating agent, greater than 60% of particles contain nucleating agent, greater than 70% of particles contain nucleating agent, greater than 80% of particles contain nucleating agent, greater than 90% of particles contain nucleating agent, greater than 95% of particles contain nucleating agent, or greater than 99% of particles contain nucleating agent. A microscale particle diameter aids in enabling the particles to be easily combined with other materials, avoiding the complexity made necessary by macroencapsulation methods. The inclusion of nucleating material in the majority of individual particles is preferred because the particles are unable to communicate with each other once they have been combined into a composite material and each phase change particle is isolated from the others. Thus, particles that do not contain a nucleator may not be thermally reversible. Such an approach may be contrasted to macroencapsulation. In the case of macroencapsulation, nucleators are easily added to each capsule of phase change material individually; however, macroencapsulation has drawbacks as previously discussed. The microparticle formation discussed herein provides a method for accomplishing nucleation at the microscale. By using a phase change material solution with the nucleating species dissolved or dispersed throughout, this method produces microscale additives that retain thermal reversibility when dispersed into an inert matrix.

According to certain embodiments, methods for coating/encapsulating microparticles are provided. Once the microemulsion process described above is completed, a coating may be added to encapsulate the microparticles. This may be performed using several different processes. One such process is to precipitate a polymer from solution onto the microparticle surface. In order to accomplish this, the microparticles are suspended by mechanical stirring in a solvent in which they are insoluble. In some embodiments, an inorganic metal salt hydrate is used as the phase change material and toluene or m-cresol is used as the solvent. The polymer intended to coat the particles is dissolved into this solution or has been dissolved before the addition of the microparticles. In some forms, the polymer is polystyrene, polycarbonate, or nylon. A stabilizer may additionally be dissolved in this solution.

While stirring the solution, a second solvent is added. The second solvent may be added slowly. This second solvent is a solvent in which the polymer is insoluble. The second solvent may be soluble in the first solvent over a wide range of concentrations. In some embodiments, the precipitating solvent is toluene or an alcohol. Upon addition, this solvent precipitates the polymer from the solution so that a coating is formed on the particles. If a stabilizer is used, it is added to the precipitating solvent as well.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

What is claimed is:

1. A composite foam insulation material, comprising:
a foam insulation matrix; and
a plurality of particles distributed within the foam insulation matrix, the particles having an average diameter of between 0.1 and 200 microns and comprising a thermally-cyclable inorganic phase change material capable of undergoing a reversible phase change.

2. The material of claim 1, wherein the particles further comprise a nucleating agent.

3. The material of claim 2, wherein the thermally-cyclable inorganic phase change material comprises an inorganic salt solvate.

4. (canceled)

5. The material of claim 3, wherein the phase change material has a first melting temperature, the nucleating agent has a second melting temperature, and the second melting temperature is greater than that of the first melting temperature.

6. The material of claim 3, wherein the plurality of particles comprise more than 0.5% nucleating agent by weight and less than or equal to 10% nucleating agent by weight.

7. The material of claim 2, wherein the thermally-cyclable inorganic phase change material has a specific latent heat of fusion of greater than or equal to 80 J/g and less than or equal to 400 J/g.

8. The material of claim 2, wherein the thermally-cyclable inorganic phase change material is capable of undergoing a reversible phase change within a temperature range of 5° C.

9-10. (canceled)

11. The material of claim 1, wherein the foam insulation matrix comprises a closed-cell foam insulation matrix.

12-13. (canceled)

14. The material of claim 1, wherein the foam insulation matrix comprises a material selected from the group consisting of polystyrene, polyurethane, polyisocyanurate, and polyethylene.

15. The material of claim 1, wherein the composite insulation material comprises greater than 0.5% and less than or equal to 50% particles by volume.

16. A composition, comprising:
a plurality of particles, the particles having an average diameter of between 0.1 and 200 microns and comprising a nucleating agent and a thermally-cyclable inorganic phase change material capable of undergoing a reversible phase change.

17. The composition of claim 16, wherein the thermally-cyclable inorganic phase change material comprises an inorganic salt solvate.

18. (canceled)

19. The composition of claim 16, wherein the nucleating agent comprises hydrated strontium chloride.

20. The composition of claim 16, wherein at least 95% of the total number of particles in the composition include nucleating agent.

21. (canceled)

22. The composition of claim 16, wherein the plurality of particles comprise more than 0.5% nucleating agent by weight and less than or equal to 10% nucleating agent by weight.

23. The composition of claim 16, wherein each of the plurality of particles further comprises an encapsulant.

24. (canceled)

25. The material of claim 16, wherein the thermally-cyclable inorganic phase change material is capable of undergoing a reversible phase change within a temperature range of 5° C.

26. (canceled)

27. A method of forming a composite insulation material, comprising:
mixing together a plurality of particles and a precursor of a foam insulation matrix, wherein the particles have an average diameter of between 0.1 and 200 microns and comprise a thermally-cyclable phase change material capable of undergoing a reversible phase change; and
allowing the precursor to foam and cure to form a composite insulation material comprising the plurality of particles distributed in a foam insulation matrix.

28. The method of claim 27, wherein the particles further comprise a nucleating agent.

29. The method of claim 27, further comprising spraying or extruding the mixture of precursor and phase change particles.

30-38. (canceled)
